(19) United States
(12) Patent Application Publication
(10) Pub. No.: US 2015/0006794 A1
(43) Pub. Date: Jan. 1, 2015

(54) APPARATUS AND METHOD FOR CONTROLLING MULTI-WAY NAND FLASHES BY USING INPUT-OUTPUT PINS

(71) Applicant: Industry-University Cooperation Foundation Hanyang University, Seoul (KR)

(72) Inventors: Soo Yong Kang, Gyeonggi-do (KR); You Jip Won, Gyeonggi-do (KR); Jae Hyuk Cha, Gyeonggi-do (KR); Sung Roh Yoon, Seoul (KR); Myung Hyun Rhee, Seoul (KR); Jong Moo Choi, Gyeonggi-do (KR)

(73) Assignee: Industry-University Cooperation Foundation Hanyang University, Seoul (KR)

(21) Appl. No.: 14/366,496

(22) PCT Filed: Dec. 10, 2012
(86) PCT No.: PCT/KR2012/010696

§ 371 Date: Jun. 18, 2014

(30) Foreign Application Priority Data
Dec. 23, 2011 (KR) 10-2011-0141318
Aug. 21, 2012 (KR) 10-2012-0091358

(51) Int. Cl. G06F 3/06

(52) U.S. Cl. CPC G06F 3/0659; G06F 3/0688; G06F 3/061
USPC 711/103

(57) ABSTRACT

The present invention relates to an apparatus and method for controlling multi-way NAND flashes using input-output pins. The apparatus for controlling multi-way NAND flashes includes: a NAND flash monitor for confirming each state of a plurality of NAND flashes by using a read status command which checks whether an inner operation of the NAND flash is performed normally; and a scheduler for determining the order in which each of the NAND flashes occupies an input-output bus.

### TECHNICAL FIELD

The present invention relates to a method and apparatus for controlling multi-way NAND flashes using input/output (I/O) pins.

### BACKGROUND ART

A NAND flash is provided in a form of a flash memory to freely store and/or delete data, and continuously store the data in a state in which power is not supplied. In general, a reading speed of the NAND flash may be slower than that of a NOR flash. However, due to a fast writing and deletion speed, and a high capacity, the NAND flash is widely being used for data storing in an electronic device such as a moving picture experts group (MPEG)-1 or MPEG-2 audio layer III (MP3), a mobile phone, a digital camera, a portable storage device, a personal computer, and the like.

In general, a controller may control such a NAND flash and verify a status of the NAND flash using a ready/busy (R/B) pin of the NAND flash. However, with developments of semiconductor and memory technologies, a number of NAND flashes included in a single storage device has increased. Thus, a method of grouping a plurality of NAND flashes and managing the plurality of NAND flashes using a single R/B pin is used to control multi-way NAND flashes. However, since the plurality of NAND flashes is managed in a single group in the method, respective statuses of the NAND flashes may not be determined individually.

### DISCLOSURE OF INVENTION

### Technical Goals

An aspect of the present invention provides a method and apparatus for controlling multi-way NAND flashes using an input/output (I/O) pin so as to check statuses of all NAND flashes despite a decrease in a number of pins of a controller controlling a plurality of NAND flashes.

Another aspect of the present invention also provides a method and apparatus for controlling multi-way NAND flashes using an I/O pin, thereby minimizing a reduction in a speed despite a decrease in a number of pins of an NAND flash controller.

### Technical solutions

According to an aspect of the present invention, there is provided a multi-way NAND flash control apparatus including a NAND flash monitor to verify a status of each of a plurality of NAND flashes using a read status command to check whether an internal operation of each of the NAND flashes is normally performed and a scheduler to determine a priority order in which each of the plurality of NAND flashes is to occupy an input/output (I/O) bus, based on the verified status.

The NAND flash monitor may determine a time for verifying the status of each of the NAND flashes by using a polling scheme, based on a pre-generated timetable.

The timetable may be generated based on information on a minimum internal operation time of a command for each of the NAND flashes, and information on an internal operation time of each of the NAND flashes with respect to the command.

The NAND flash monitor may verify whether the internal operation is completed using the read status command.

The NAND flash monitor may verify the status of each of the plurality of NAND flashes using the read status command, in lieu of a ready/busy (R/B) pin.

The scheduler may determine a priority order in which each of the NAND flashes is to occupy the I/O bus using an interleaving scheme.

According to another aspect of the present invention, there is also provided a multi-way NAND flash control method including verifying, by a NAND flash control apparatus, a status of each of the NAND flashes using a read status command to check whether an internal operation of each of the NAND flashes is normally operated, and determining a priority order in which each of the NAND flashes is to occupy an I/O bus, based on the verified status.

According to still another an aspect of the present invention, there is also provided a NAND flash memory device including a plurality of NAND flashes, a register to store a command for an operation to be performed by each of the NAND flashes and information on an address of a NAND flash performing the operation, a NAND flash controller to verify a status of each of the NAND flashes using a read status command stored in the register to check whether an internal operation of each of the NAND flashes is normally performed, and determine a priority order in which each of the NAND flashes is to occupy an I/O bus, based on the verified status, and a buffer to temporarily store data transmitted between each of the NAND flashes and the NAND flash controller.

### Advantageous Effects

According to an aspect of the present invention, it is possible to verify a status of each of NAND flashes using a read status command in lieu of a ready/busy (R/B) pin, and determine a priority order in which each of the NAND flashes is to occupy an input output (I/O) bus, based on the verified status, thereby easily designing a controller and monitoring/controlling each of the NAND flashes individually.

According to another aspect of the present invention, it is possible to determine a time for verifying a status of each NAND flashes using a timetable generated based on information on a minimum internal operation time of a command for each of the NAND flashes, and information on an internal operation time of each of the NAND flashes with respect to the command, and schedule reading/writing and occupying an I/O bus based on a result of the determining, thereby minimizing a reduction in a speed despite a decrease in a number of pins of an NAND flash controller.

### BRIEF DESCRIPTION OF DRAWINGS

FIG. 1 is a diagram illustrating a NAND flash.

FIG. 2 is a block diagram illustrating a NAND flash memory device according to an embodiment of the present invention.

FIG. 3 is a flowchart illustrating a multi-way NAND flash control method according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

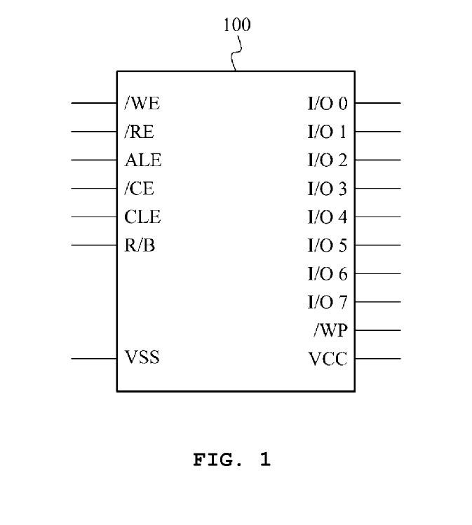

FIG. 1 is a diagram illustrating a NAND flash.

Referring to FIG. 1, a NAND flash 100 may include a plurality of input/output (I/O) pins, a write protect (WP) pin, a voltage controller (VCC) pin, a voltage source (VSS) pin, a ready/busy (R/B) pin, a command latch enable (CLE) pin, a chip enable (CE) pin, an address latch enable (ALE) pin, a read enable (RE) pin, and a write enable (WE) pin.

An I/O pin may be a pin used to input and output data and an address. The NAND flash 100 may commonly use an address line and a data line in a single port in contrast to an existing memory. Thus, the NAND flash 100 may include the CLE pin and the ALE pin to verify whether data transmitted through the single port is a command or an address.

The CLE pin may provide notification on an output of a command, for example, read, write, and delete through an I/O bus. When a CLE is high, data output to the I/O bus may be a command transmitted to the NAND flash 100.

The ALE pin may provide information on an output of an address through the I/O bus. When the ALE pin is high, data output to the I/O bus may be an address transmitted to the NAND flash 100. When both the CLE pin and the ALE pin are low, data may be output to the I/O bus.

The RE pin and the WE pin are pins indicating reading and writing of data. When data is read, the RE pin may be low. When data is written, the WE pin may be low. to The CE pin may indicate whether the NAND flash 100 is being used by a processor.

The R/B pin may be a pin indicating a status of the NAND flash 100. When the R/B pin is low, the status may correspond to “busy”. When the R/B pin is high, the status may correspond to “ready”.

To configure multi-way NAND flashes by using a plurality of NAND flashes including the NAND flash 100, a status of each of the NAND flashes may need to be verified in real-time. Operations of the NAND flashes may include transferring a command, an internal operation of a flash, verifying success of the internal operation, and a post-operation, for example, reading, writing, deleting, and the like. The internal operation may account for the greatest amount of time among overall operations. A writing operation may account for ten to twenty times time as compared to other operations. A reading operation may account for more than five times an amount of time in comparison to other operations. Such a status of the internal operation may be verified using the R/B pin of the NAND flash 100.

The B/B pin may generally have a value corresponding to high. When a flash is performing the internal operation, the value may be changed to be low, and changed again to be high at a moment of completing the operation. Thus, a current status of the NAND flash 100 may be indicated through the R/B pin.

However, to develop a high-capacity storage device, a number of NAND flash chips included in a single storage device is increasing, and one or two R/B pins may be included in a single NAND flash chip. Thus, in an existing NAND flash control apparatus, a number of pins for controlling NAND flash chips may correspondingly increase according to an increase in the number of NAND flash chips included in the single storage device.

Accordingly, a multi-way NAND flash control apparatus according to an embodiment of the present invention may reduce the number of pins by removing the R/B pin, and use a timetable to check a status of each NAND flash at a speed approximately equal to a speed of a case of using the R/B pin.

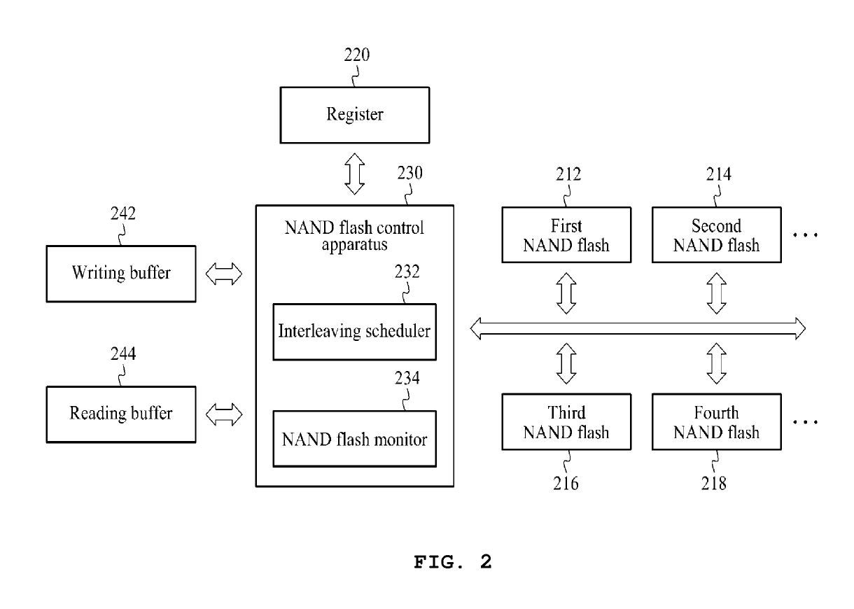

FIG. 2 is a block diagram illustrating a NAND flash memory device including a multi-way NAND flash according to an embodiment of the present invention. Hereinafter, descriptions about a multi-way NAND flash control apparatus according to an embodiment of the present invention will be provided with reference to FIG. 2.

The NAND flash memory device may include a plurality of NAND flashes, for example, a first NAND flash 212, a second NAND flash 214, a third NAND flash 216 and a fourth NAND flash 218, a register 220, a NAND flash control apparatus 230, and buffers, for example, a writing buffer 242 and a reading buffer 244.

Each of the NAND flashes may perform an operation of reading, writing, and deleting in response to a control of the NAND flash control apparatus 230.

The register 220 may receive a command such as read, write, delete, and the like from an upper controller to transmit to the NAND flash control apparatus 230. In the register 220, a command for an operation to be performed by each of the NAND flashes, and information on an address of a NAND flash to perform the command may be stored.

The buffers may temporarily store data transmitted between each of the NAND flashes and the NAND flash control apparatus 230 in a process of reading/writing. The buffers may be implemented by the writing buffer 242 and the reading buffer 244 as shown in FIG. 2.

In this example, the writing buffer 242 may receive data in a reading operation from an upper controller through a bus, and then, when preparations are completed, transfer the data to a corresponding NAND flash using the NAND flash control apparatus 230.

Similarly, the reading buffer 244 may read data in a writing operation from a NAND flash using the NAND flash control apparatus 230, temporarily store the data, and then, transfer the data to the upper controller through the bus.

The NAND flash control apparatus 230 may verify respective statuses of the NAND flashes using a read status command, and determine a priority order in which the NAND flashes occupy an I/O bus based on the verified statuses.

In this example, the read status command may be one of commands stored in the register 220. When an R/B pin is present, the read status command may perform a function to verify whether an internal operation is normally completed when the internal operation of each NAND flash is completed. The read status command may be a mandatory command. A result value may be received through an I/O pin. In this instance, the NAND flash control apparatus 230 may also verify whether the internal operation is completed based on the read status command. For example, the NAND flash control apparatus 230 may verify completion of the internal operation using a sixth I/O pin among eight I/O pins, and determine whether the internal operation is successful using a zeroth I/O pin.

To this end, in an example, the NAND flash control apparatus 230 may include an interleaving scheduler 232 and a NAND flash monitor 234 as shown in FIG. 2.

The interleaving scheduler 232 may generate a control signal for each of the NAND flashes based on specifications of the NAND flashes supporting various commands, and schedule a priority order in which multi-way NAND flashes occupy I/O buses based on an interleaving scheme.

The NAND flash monitor 234 may verify the status, for example, whether the internal operation is completed for each of the NAND flashes using the read status command based on a pre-generated timetable.

When the R/B pin is present, notification as to completion of an operation for each NAND flash may be provided at a moment of changing a value from low to high based on an interrupt scheme. However, in a case of using the read status command, the interrupt scheme may not be applied and thus, a polling speed may be optimized based on a polling scheme adopting characteristics described below.

1. An internal operation time may differ for each flash chip.

2. An average speed of each command may be provided in a data sheet.

3. A time for performing a predetermined command may be approximately equal to a previous time.

By applying the aforementioned characteristics, the NAND flash control apparatus 230 may generate a timetable based on data described below. In this regard, a time for reading a status of a NAND flash based on the polling scheme may be determined.

1. A minimum internal operation time of a command for each NAND flash

2. An internal operation time of each NAND flash with respect to the command.

In an initial timetable, a minimum value regarding the data sheet may be set, and an actual polling initiation time may be set to be earlier than or equal to a reference time. Also, when the I/O pin is occupied by another NAND flash, a priority order in which each NAND flash is to be subsequently checked may be determined based on the timetable.

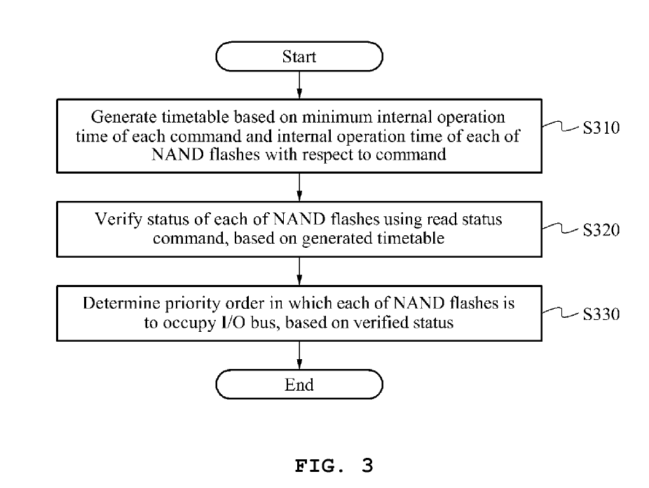

FIG. 3 is a flowchart illustrating a multi-way NAND flash control method according to an embodiment of the present invention. Hereinafter, descriptions about the multi-way NAND flash control method will be provided with reference to FIG. 3.

In operation S310, to minimize an amount of speed decrease occurring when a plurality of NAND flashes is controlled using a read status command in lieu of an R/B pin, a timetable may be generated based on information on a minimum internal operation time of a command for each of the NAND flashes, and information on an internal operation time of each of the NAND flashes with respect to the command.

In operation S320, a time for verifying a status of each of the NAND flashes may be determined using a polling scheme based on the generated timetable, and whether an internal operation of each NAND flash is completed may be verified using the read status command.

In operation S330, when the status is verified, a priority order in which each of the NAND flashes is to occupy an I/O bus may be determined In this example, the priority to order in which each of the NAND flashes is to occupy the I/O bus may be determined using an interleaving scheme.

Accordingly, in a multi-way NAND flash control method and apparatus using an I/O pin according to an embodiment of the present invention, since a status of each NAND flash may be verified using a read status command in lieu of an R/B pin, a number of pins required for a controller may be significantly reduced. Thus, the controller may be easily designed while each NAND flash is being independently monitored and/or controlled.

Also, since a time for verifying a status of each NAND flash is determined using a timetable generated based on information on a minimum internal operation time of a command for each NAND flash and information on an internal operation time of each NAND flash with respect to the command, and reading/writing and occupying an I/O bus may be scheduled based on a result of the determining, the decrease in the speed may be minimized despite a decrease in the number of pins included in the NAND flash control apparatus.

The multi-way NAND flashes control method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A multi-way NAND flash control apparatus for controlling a plurality of NAND flashes, the apparatus comprising:
a NAND flash monitor to verify a status of each of the plurality of NAND flashes using a read status command to check whether an internal operation of each of the NAND flashes is normally performed; and
a scheduler to determine a priority order in which each of the plurality of NAND flashes is to occupy an input/output (I/O) bus, based on the verified status.

2. The apparatus of claim 1, wherein the NAND flash monitor determines a time for verifying the status of each of the NAND flashes by using a polling scheme, based on a pre-generated timetable.

3. The apparatus of claim 2, wherein the timetable is generated based on information on a minimum internal operation time of a command for each of the NAND flashes, and information on an internal operation time of each of the NAND flashes with respect to the command.

4. The apparatus of claim 1, wherein the NAND flash monitor verifies whether the internal operation is completed using the read status command.

5. The apparatus of claim 1, wherein the NAND flash monitor verifies the status of each of the plurality of NAND flashes using the read status command, in lieu of a ready/busy (R/B) pin.

6. The apparatus of claim 1, wherein the scheduler determines a priority order in which each of the NAND flashes is to occupy the I/O bus using an interleaving scheme.

7. A multi-way NAND flash control method of controlling a plurality of NAND flashes, the method comprising:
verifying, by a NAND flash control apparatus, a status of each of the NAND flashes using a read status command to check whether an internal operation of each of the NAND flashes is normally operated; and
determining a priority order in which each of the NAND flashes is to occupy an input/output (I/O) bus, based on the verified status.

8. The method of claim 7, further comprising:
determining a time for verifying the status of each of the NAND flashes by using a polling scheme, based on a pre-generated timetable.

9. The method of claim 8, wherein the timetable is generated based on information on a minimum internal operation time of a command for each of the NAND to flashes, and information on an internal operation time of each of the NAND flashes with respect to the command.

10. The method of claim 7, wherein the verifying comprises verifying whether the internal operation is completed using the read status command.

11. The method of claim 7, wherein the verifying comprises verifying the status of each of the plurality of NAND flashes using the read status command, in lieu of a ready/busy (R/B) pin.

12. The method of claim 7, wherein the determining comprises determining the priority order in which each of the NAND flashes is to occupy the I/O bus using an interleaving scheme.

13. A NAND flash memory device comprising:
a plurality of NAND flashes;
a register to store a command for an operation to be performed by each of the NAND flashes and information on an address of a NAND flash performing the operation;
a NAND flash controller to verify a status of each of the NAND flashes using a read status command stored in the register to check whether an internal operation of each of the NAND flashes is normally performed, and determine a priority order in which each of the NAND flashes is to occupy an input/output (I/O) bus, based on the verified status; and
a buffer to temporarily store data transmitted between each of the NAND flashes and the NAND flash controller.

14. The device of claim 13, wherein the NAND flash controller determines a time for verifying the status of each of the NAND flashes using a polling scheme based on a timetable generated based on information on a minimum internal operation time of a command for each of the NAND flashes, and information on an internal operation time of each of the NAND flashes with respect to the command.

15. The device of claim 13, wherein the NAND flash controller verifies whether the internal operation is completed using the read status command, in lieu of a ready/busy (R/B) pin, and
determines the priority order in which each of the NAND flashes is to occupy the I/O bus using an interleaving scheme.
